(19) United States
(12) Patent Application Publication
(10) Pub. No.: US 2021/0087106 A1
(43) Pub. Date: Mar. 25, 2021

(54) ANTI-GLARE GLASS SHEET

(71) Applicants: AGC GLASS EUROPE, Louvain-la-Neuve (BE); AGC INC., Chiyoda Ku, Tokyo (JP); AGC FLAT GLASS NORTH AMERICA INC., Alpharetta, GA (US); AGC VIDROS DO BRASIL LTDA, Sao Paulo, Guaratingueta (BR)

(72) Inventors: Benjamine NAVET, Louvain-La-Neuve (BE); Amory JACQUES, Jambes (BE)

(73) Assignees: AGC GLASS EUROPE, Louvain-la-Neuve (BE); AGC INC., Chiyoda Ku, Tokyo (JP); AGC FLAT GLASS NORTH AMERICA INC., Alpharetta, GA (US); AGC VIDROS DO BRASIL LTDA, Sao Paulo, Guaratingueta (BR)

(21) Appl. No.: 16/977,703

(22) PCT Filed: Feb. 21, 2019
(86) PCT No.: PCT/EP2019/054336

§ 371 Date: Sep. 2, 2020

(30) Foreign Application Priority Data
Mar. 5, 2018 (EP) 18159972.1

(51) Int. Cl. C03C 23/00; C03C 15/00

(52) U.S. Cl. CPC C03C 23/0055; C03C 2204/08; C03C 2217/734; C03C 15/00

(57) ABSTRACT

A glass sheet comprising at least one antireflective, etched surface having a surface roughness defined, when measured on an evaluation length of 12 mm and with a Gaussian filter with a cut-off wavelength is 0.8 mm, by: 0.02≤Ra≤0.6 μm; 0.1≤Rz≤3 μm; and 5≤RSm≤180 μm. The glass sheet has the following optical properties, when measured from the antireflective, etched surface: a haze value of from 1 to 40%; a clarity value of from 30 to 100%; a gloss value at 60° of from 20 to 130 SGU; and a luminous reflectance Rc from 4 to 7%. The antireflective, etched surface comprises implanted ions. Such a glass sheet is particularly suitable for display applications as cover glass and has excellent sparkle reduction properties together with an anti-glare effect.

### TECHNICAL FIELD

The present invention relates to a glass sheet having low reflectance, which is suitable for cover glasses and particularly suitable for display applications as cover glass. In particular, the invention relates to such a glass sheet which has excellent low sparkle properties together with an anti-glare effect. Moreover, the glass sheet of the invention also combines low reflectance, anti-glare and low sparkle properties with a “soft touch”.

### BACKGROUND ART

The glare reduction of a smooth surface, like for example a glass sheet, is particularly useful, or even mandatory, in display applications where bright light sources are present like in outdoor use where glare is often significant due to sunlight. Texturing a glass surface is widely used in the display industry for the reduction of glare. This texturing can be produced by several known methods like (i) removal of material from the smooth glass surface by chemical etching or by sandblasting or (ii) the application on the smooth surface of a rough coating by, for example, spraying, polymer web-coating or dip-coating.

Generally, a compromise must be made between glare reduction of the surface and the degradation of transmission/resolution properties of the glass. In particular, increasing the texture or roughness of a glass surface generally leads to undesired increase in haze and undesired rough touch feeling.

Moreover, with recent increases in the brightness and resolution of displays on the market, another serious issue for display developers has appeared. Indeed, an additional drawback of texturing a smooth surface to reduce glare in displays is the appearance of a detrimental effect for viewers called “sparkle”.

Finally, there has been in recent years a huge development of tactile/touch technologies for displays. At the same time there is an increasing demand in the display market for combined anti-glare and low sparkle solutions for cover glass sheets that maintain or improve the pleasantness and smoothness of the smooth touch sensation (often called a satin, silk or soft touch).

WO2016005216 for instance discloses a glass with very low sparkle combined with an antiglare effect. This glass presents a certain surface roughness which is obtained by acid etching.

Despite these advantageous properties, the reflectance of these glass substrates is still too high for certain situations were for example very strong light sources are present.

It is known to add anti-reflective coatings to flat glass substrates. These may for example be sol-gel based coatings having an intermediate refractive index, between the refractive index of the glass substrate and the refractive index of air. These may also be multilayer coatings, based on alternating thin layers of low index materials with thin layers of high index materials. As was found by the inventors, on acid-etched rough substrates these coatings are however often difficult to apply uniformly, this is particularly the case for sol-gel based coatings which also reduce the surface roughness. These coatings may also yield unexpected and undesired results regarding the color of the reflected light.

### SUMMARY OF INVENTION

The objective of the invention in particular is to remedy the cited disadvantages and resolving the technical problem, i.e. to provide a glass sheet with an anti-glare effect, and low reflectance, with a color in reflection which is angularly stable.

Another objective of the invention in at least one of its embodiments is to provide a glass sheet which shows very low or no sparkle combined with an antiglare effect, low reflectance, with a color in reflection which is angularly stable. and neutral color in reflection which is angularly stable.

Another objective of the invention in at least one of its embodiments is to provide a glass sheet which shows very low or no sparkle combined with an antiglare effect, low reflectance and neutral color in reflection which is angularly stable.

Another objective of the invention in at least one of its embodiments is to provide a glass sheet which shows very low or no sparkle, low reflectance and with a color in reflection which is angularly stable, combined with a “soft touch”,

Another objective of the invention in at least one of its embodiments is to provide a glass sheet which shows very low or no sparkle, low reflectance and, with a color in reflection which is angularly stable, which is chemically and/or thermally temperable.

It is noted that the invention relates to all possible combinations of features recited in the claims.

### DESCRIPTION OF EMBODIMENTS

The invention relates to a glass sheet comprising at least one antireflective, etched surface having a surface roughness defined, when measured on an evaluation length of 12 mm and with a Gaussian filter of which the cut-off wavelength is 0.8 mm, by:

0.02≤Ra≤0.6 μm,

0.1≤Rz≤3 μm and

5≤RSm≤180 μm,

wherein the antireflective, etched surface comprises implanted ions of 0, N, He, Ne, Ar, or Kr, with an implantation depth comprised between 0.1 μm and 1 μm, said glass sheet having the following optical properties, when measured from said antireflective, etched surface:

a haze value of from 1 to 40%,

a clarity value of from 30 to 100%,

a gloss value at 60° of from 20 to 130 SGU, and

a visible light reflectance of from 7 to 4.5%.

These properties may be obtained in the absence of any coating or surface treatment on the surface opposite to the antireflective, etched surface. The etched glass sheets according to the invention have preferably low sparkle values of less than 5%, in particular less 4%, in particular less than 3%, when measured following the method detailed below together with the examples part of the specification.

Hence, the invention rests on a novel and inventive approach, since it enables a solution to be found for the disadvantages of prior art. The inventors have indeed found that it is possible to obtain an excellent antireflective, anti-glare and low sparkle glass sheet, with pleasant smooth touch feeling, by considering a glass surface with a specific fine-tuned roughness together with low reflectance. Ion implantation of a glass substrate having such a fine-tuned roughness, which is not significantly affect by ion implantation, surprisingly leads to a uniform visual aspect despite the three-dimensional nature of the surface.

Throughout the present text, when a numerical range is indicated, the limits of the range are considered to be included in the range. In addition, all the integral and subdomain values in the numerical range are expressly included as if explicitly written.

Other features and advantages of the invention will be made clearer from reading the following description of preferred embodiments given by way of simple illustrative and non-restrictive examples.

According to the invention, the glass sheet comprises at least one antireflective, etched surface.

By “etched surface”, it is meant a surface which has been attacked by a mechanical or chemical way, removing a certain amount of glass material and giving a specific surface texture/roughness. We talk about chemically-etched glass when material removal occurs by chemical reactions/attack (i.e. acid etching). We talk about mechanically-etched glass when material removal occurs by mechanical reactions/attack (i.e. sandblasting). According to the invention, said at least one etched surface may be etched advantageously over substantially the entire glass surface, that-is-to-say over at least 90% of the glass surface.

By antireflective, etched surface, it is meant that after etching, the etched surface has been submitted to ion implantation so as to lower the glass sheet's visible light reflectance.

The antireflective, etched surface of a glass sheet is usually characterized by its surface texture or roughness, and in particular, by the Ra, Rz and Rsm values (expressed in μm) defined in the standard ISO 4287-1997. The texture/roughness is a consequence of the existence of surface irregularities/patterns. These irregularities consist of bumps called “peaks” and cavities called “valleys”. On a section perpendicular to the antireflective, etched surface, the peaks and valleys are distributed on either side of a “center line” (algebraic average) also called “mean line”. In a profile and for a measurement along a fixed length (called “evaluation length”):

i) Ra (amplitude value) corresponds to the average difference of texture, that is, means the arithmetic average of absolute values of differences between the peaks and valleys. Ra measure the distance between this average and the “line” and gives an indication of the height of the patterns on the antireflective, etched surface;

ii) Rz (amplitude value) corresponds the “ten-point mean roughness” and is the sum of the average peak among 5 tallest peaks and the average valley between 5 lowest valleys.

iii) RSm (spacing value, sometimes also called Sm) is the average distance between two successive passages of the profile through the “mean line”; and this gives the average distance between the “peaks” and therefore the average value of the widths of the patterns.

The roughness values according to the invention may be measured with a profilometer using 2D profiles (according to the ISO4287 standard). Alternatively, one can use the technique of 3D profilometry (according to the ISO 25178 standard) but isolating a 2D profile which then gives access to the parameters defined in the ISO4287 standard.

According to the invention, the roughness values are measured with a Gaussian filter, which is a filter of long wavelengths, also called profile filter λc. It is used for separating the components of roughness/texture from components of undulation of the profile.

The evaluation length L according to the invention is the length of the profile used to evaluate the roughness. Base length, l is the part of the evaluation length used to identify irregularities characterizing the profile to assess. The evaluation length L is divided/cut into n base lengths l which depend on the profile irregularities. The base length l corresponds to the “cut-off” wavelength (or limit wavelength) of the Gaussian filter (l=λc). Typically, the evaluation length is of at least five times the base length.

In roughness measurements, a short wavelength filter (profile filter λs) is also commonly used to eliminate the effects of very short wavelengths which are background noise.

The visible light reflectance Rc is measured on the etched and ion implanted surface (or side) of the glass sheet using illuminant D65 and a 2° observer angle. The color in reflection is expressed using CIELAB color coordinates a* and b* under illuminant D65 using 10° observer angle and is measured on the on the etched and ion implanted side of the glass sheet. CIE L*a*b* or CIELAB is a color space specified by the International Commission on Illumination and is routinely used in glass industry among others. Unless specified otherwise, the visible light reflectance Rc, and the colors in reflection a*Rc, b*Rc are measured at an angle of 8°, close to perpendicular to the glass sheet surface. Values measured at other angles are identified by specifying the measurement angle within brackets, i.e. Rc_{(35°)}, a*_{Rc(35°)}, b*_{Rc(35°)}. The transmittance TL is measured also using illuminant D65 and a 2° observer angle.

According to one embodiment of the invention, the surface roughness of the antireflective, etched surface of the invention is such as: 10≤RSm≤180 μm. Alternatively, the surface roughness of the antireflective, etched surface of the invention is such as: 10≤RSm≤140 μm or 10≤RSm≤100 μm or 10≤RSm≤60 μm. According to another embodiment of the invention the surface roughness is such as 10≤RSm≤20 μm. Lower RSm roughness values, possibly in combination with certain haze and gloss values, provide the glass sheet of the invention with lower sparkle values.

The inventors had observed a certain amount of sputtering of the surface when implantation was performed on flat glass substrates. Depending on implantation parameters, up to several tens of nanometres of the surface could be removed. Furthermore a certain amount of structural changes in the glass matrix were observed in a wide range of implantation parameters on flat glass. Despite this, it was found that the ion implantation according to the present invention most surprisingly resulted in only insignificant changes of the surface roughness parameters. According to the present invention the surface roughness parameter ranges described herein are the same for the etched glass sheet before ion implantation and for the antireflective, etched glass sheet.

According to another advantageous embodiment of the invention, the surface roughness of the antireflective, etched surface of the invention is such as: 0.02≤Ra≤0.6 μm. Alternatively, the surface roughness of the antireflective, etched surface of the invention is such as: 0.02≤Ra≤0.4 or even 0.02≤Ra≤0.2 μm. Lower values of Ra provide the glass sheet of the invention a lower haze value.

According to another advantageous embodiment of the invention, the surface roughness of the antireflective, etched surface of the invention is such as: 0.1≤Rz≤3.0 μm, or 0.2≤Rz≤2.5 μm, or even 0.2≤Rz≤1.5 μm.

In an embodiment of the invention the ion implantation results in a reduction of the visible light reflectance of this etched glass and a low angular color variation of the reflected light in the visible range. In particular the color variation between 8° (i.e. close to perpendicular) and a 35° angle or even up to 75°. The color variation is expressed by the calculation of Δa*b*_{Rc} of the reflected light. The lower this value is, the lower is the angular color variation. The value of Δa*b*_{Rc} is calculated from the a*_{Rc}, b*_{Rc} values (CIELAB L*a*b*−D65−10°) measured at different observation angles. The angle of observation a (chosen between 8° and 75°) is the angle of observation of the observer or of the measurement apparatus in relation to an axis perpendicular to the substrate (α=0°). The Δa*b*_{Rc} value can be determined for different angles of observation, for instance 8°, 15°, 20°, 25°, 30°, 35°, 45°, 50°, 55°, 60°, 65°, 70°, and 75°. Thus, the variation for an angle of 35° is Δa*b*_{Rc)(35°)}=[(a*_{Rc(8°)}−a*_{Rc(35°)})²+(b*_{Rc(8°)}−b*_{Rc(35°)})²]^{1/2}.

In an embodiment of the present invention the ion implantation results in a low angular color variation Δa*b*_{Rc(35°)}≤1.5, or a an angular color variation Δa*b*_{Rc)(35°)}≤1, or an angular color variation Δa*b*_{Rc(35°)}≤0.7, or a particularly low angular color variation Δa*b*_{Rc(35°)}≤0.5. In certain embodiments Δa*b*_{Rc} values of at most 3, at most 2 and even at most 1 are obtained for any one or more angle mentioned of observation up to 75° mentioned above.

In an embodiment of the invention the ion implantation results in a reduction of the visible light reflectance of the glass sheet comprising at least one antireflective, etched surface and a neutral color of the reflected light. In particular the CIELAB color coordinates of the reflected light on the etched and ion implanted side of the glass substrate are, expressed by the color coordinates of a*_{Rc} and b*_{Rc} in reflection, is neutral, that is −1≤a*_{Rc}≤1 and −1≤b*_{Rc}≤1, or is more neutral, that is −0.5≤a*_{Rc}≤0.5 and −0.5≤b*_{Rc}≤0.5, or even is very neutral, that is −0.3≤a*_{Rc}≤0.3 and −0.3≤b*_{Rc}≤0.3. In some cases it is sufficiently neutral to have a color in reflection that is −2≤a*_{Rc}≤2 and −2≤b*_{Rc}≤2. In an embodiment of the present invention the ion implantation results in a low angular color variation Δa*b*_{Rc(35°)}≤1, a very low angular color variation Δa*b*_{Rc(35°)}≤0.7, or a particularly low angular color variation Δa*b*_{Rc(35°)}≤0.5 in combination with the neutral, more neutral or even very neutral colors in reflection hereinabove.

In another advantageous embodiment a bluish reflectance is obtained with −3≤a*_{Rc}≤3 and −20≤b*_{Rc}≤−3 in particular in combination with a low angular color variation Δa*b*_{Rc(35°)}≤1.5, or a an angular color variation Δa*b*_{Rc(35°)}≤1, or an angular color variation Δa*b*_{Rc(35°)}≤0.7, or a particularly low angular color variation Δa*b*_{Rc(35°)}≤0.5.

The ion implantation comprises the implantation of positively charged ions of O, N, He, Ne, Ar, or Kr so as to reduce the visible light reflectance of the etched glass sheet.

According to the present invention the implantation step comprises the following operations:

providing a source gas selected from O₂ or N₂, He, Ne, Ar, or Kr.

ionizing the source gas so as to form positively charged ions of O, N, He, Ne, Ar, or Kr,

accelerating the positively charged ions of O, N, He, Ne, Ar, or Kr with an acceleration voltage comprised between 5 kV and 100 kV,

providing a glass sheet with an etched surface, having a surface roughness defined, when measured on an evaluation length of 12 mm and with a Gaussian filter of which the cut-off wavelength is 0.8 mm, by:

0.02≤Ra≤0.6 μm,

0.1≤Rz≤3 μm and

5≤RSm≤180 μm,

positioning the glass sheet in the trajectory of the beam of positively charged ions of O, N, He, Ne, Ar, or Kr with the etched surface facing the beam.

In an embodiment of the present invention the trajectory of the ion beam is perpendicular to the etched surface of the glass sheet.

The ion dosage is comprised between 5×10¹⁴ ions/cm² and 10¹⁸ ions/cm², advantageously between 10¹⁶ ions/cm² and 5×10¹⁷ ions/cm², more advantageously between 5×10¹⁶ ions/cm² and 10¹⁷ ions/cm². The ion dosage may for example be controlled by the duration of exposure to the ion beam and also depends on the fluence of the beam.

In certain embodiments the glass sheet is moved relative to the ion beam in order to treat its entire surface.

The etched glass sheet shows after ion implantation a visible light reflectance of at most 7% and most surprisingly, despite the roughness of the antireflective, etched surface shows no visible non-uniformities and despite the ion implantation taking place at a non-perpendicular angle to the surface structures. Additionally the etched glass sheet may show after ion implantation small angular reflected color variations. In particular the etched glass sheet may also show after ion implantation a neutral color in reflection or a blue color in reflection.

According to an embodiment of the present invention the positively charged ions comprise a mixture of single and/or multiple charged ions.

The inventors have found that ion sources providing an ion beam comprising a mixture of single charge and multicharge ions, accelerated with the same acceleration voltage are particularly useful as they may provide higher fluences than single charge ion beams. They are therefore able to reach a certain dosage in a shorter amount of time. Multiple charge ions are also interesting because they reach greater implantation depths than single charge ions, for the same acceleration voltage. The implantation energy, expressed in Electron Volt (eV) is calculated by multiplying the charge of the single charge ion or multicharge ion with the acceleration voltage. An ion beam comprising a mixture of single charged ions and multi charged ions are particularly useful as for a certain acceleration voltage, a double charged ion of a certain species, for example N²⁺, will have double the implantation energy of the corresponding single charge ion, N. Thereby greater implantation depths can be reached without having to increase the acceleration voltage. In an embodiment of the present invention the ion beam at least 90% of the ions in the ion beam are made up of the single charge and double charge ions of a species selected from N, O, He, Ne, Ar, Kr and the ratio of single charge species and double charge species is at least 55/25. The respective single charge and double charge species are N⁺ and N²⁺, O⁺ and O²⁺, He⁺ and He²⁺, Ne⁺ and Ne²⁺, Ar⁺ and Ar²⁺.

In a preferred embodiment of the present invention the temperature of the area of the glass substrate being treated, situated under the area being treated is less than or equal to the glass transition temperature of the glass substrate. This temperature is for example influenced by the ion current of the beam, by the residence time of the treated area in the beam and by any cooling means of the substrate.

In a preferred embodiment of the invention implanted ions of either N or O are used as they show less sputtering than heavier ions, which is particularly important to maintain the surface roughness obtained by etching. In another embodiment of the invention implanted ions of N and O are combined.

In one embodiment of the invention several ion implantation beams are used simultaneously or consecutively to treat the glass substrate.

In one embodiment of the invention the total dosage of ions per surface unit of an area of the glass substrate is obtained by a single treatment by an ion implantation beam.

In another embodiment of the invention the total dosage of ions per surface unit of an area of the glass substrate is obtained by several consecutive treatments by one or more ion implantation beams. The ion beams may use the same or different source gases to implant the same or different ions of O, N, He, Ne, Ar, or Kr.

The method of the present invention is preferably performed in a vacuum chamber at a pressure comprised between 10⁻² mbar and 10⁻⁷ mbar, more preferably at a pressure comprised between 5×10⁻⁵ mbar and 6×10⁻⁶ mbar.

An example ion source for carrying out the method of the present invention is the Hardion+RCE ion source from Ionics SA.

The present invention also concerns the use of a mixture of single charge and multicharge ions of O, N, He, Ne, Ar, or Kr to decrease the reflectance of an etched glass substrate, the mixture of single charge and multicharge ions being implanted in the glass substrate with an ion dosage and acceleration voltage effective to reduce the reflectance of the glass substrate.

Advantageously the mixture of single and multicharge ions of O, N, He, Ne, Ar, or Kr is used with an ion dosage and acceleration voltage effective to reduce the visible light reflectance of a glass substrate to at most 6.5%, preferably to at most 6%, more preferably to at most 5.5%. In any case the reflectance will be at least 4%, due to the reflectance from the side opposite to the antireflective etched surface as is well known to the person skilled in the art.

Advantageously the implantation depth of the ions may be comprised between 0.1 μm and 1 μm, preferably between 0.1 μm and 0.5 μm. The implanted ions are spread between the substrate surface and the implantation depth. The implantation depth may be adapted by the choice of implanted ion, by the acceleration energy and varies to a certain degree depending on the substrate.

According to the present invention, the mixture of single charge and multicharge ions of O or N preferably comprises, O⁺ and O²⁺ or N⁺, N²⁺ and N³⁺ respectively.

According to a preferred embodiment of the present invention, mixture of single charge and multicharge ions of O comprises a lesser amount of O²⁺ than of O⁺. In a more preferred embodiment of the present invention the mixture of single charge and multicharge ions of 0 comprises 55-98% of O⁺ and, 2-45% of O²⁺.

According to another preferred embodiment of the present invention, mixture of single charge and multicharge ions of N comprises a lesser amount of N³⁺ than of N⁺ and of N²⁺ each. In a more preferred embodiment of the present invention the mixture of single charge and multicharge ions of N comprises 40-70% of N⁺, 20-40% of N²⁺, and 2-20% of N³⁺.

The glass sheet according to the invention shows excellent low sparkle properties together with an anti-glare effect.

The “anti-glare” property deals with external sources of reflection off a surface—like sunlight or ambient lighting conditions—and its impact on the readability of the image or information you are trying to read through the surface. It refers to the property of changing light reflected from the surface of an article, such as a glass sheet, into a diffuse reflection rather than a specular reflection. Anti-glare property does not reduce the global amount of light reflected from the surface but it only changes the characteristics of the reflected light (diffused component of reflected light increases when anti-glare effect increases).

“Sparkle” refers to small bright spots (approximately at the pixel-level size scale) that appear in the instant texture of an image of a display screen through an anti-glare glass surface and which gives to the transmitted image a grainy appearance. The “sparkling effect” is thus an optical interaction between two surface areas: the regular display pixel matrix (light source) and the anti-glare glass surface with less regular microstructures. It appears as a random fluctuation in intensity on a display (involving refraction, diffraction, diffusion phenomena) as the viewer's head moves from side-to-side.

The optical properties of the glass sheet according to the invention are characterized by:
the direct total light transmission (or specular light transmission) TL;
the diffuse light transmission, measured through (i) the “haze” and (ii) the “clarity”: the “haze” corresponds to the diffuse transmittance at wide angles scattering while the “clarity” corresponds to the diffuse transmittance at narrow angles scattering;
and
the gloss, characterizing, for example, the brightness or shine of a surface, and more particularly corresponding to the specular reflectance of a surface relative to a standard (such as, for example, a certified black glass standard) in accordance with ASTM standard D523 at a specific angle, and it is expressed in SGU (standard gloss units).

All optical properties are measured on an antireflective, etched glass sheet of the present invention without any additional coating or surface treatment on the surface opposite the antireflective, etched surface.

The term “diffuse” used for the light transmission is the proportion of light which, when passing through the glass, is deflected from the incident beam by dispersion of more than 2.5°. The term “diffuse” used for the light reflection is the proportion of light which, by reflection at the glass/air interface, is deflected from the specularly reflected beam by dispersion of more than 2.5°.

The optical properties of the glass sheet are measured in the present invention from the antireflective, etched surface.

In an embodiment of the present invention, the glass sheet has the following optical properties, when measured from said antireflective, etched surface:
a haze value of from 1 to 40%;
a clarity value of from 50 to 100%;
a gloss value at 60° of from 20 to 110 SGU.

According to an advantageous embodiment of the invention, and depending on the chosen application, the glass sheet has a haze of from 1 to 20%. More preferably, the glass sheet has a haze of from 1 to 15%. According to another advantageous embodiment of the invention, the glass sheet has a haze of from 30 to 40%, or of from 20 to 30%.

According to another advantageous embodiment of the invention, the glass sheet has a clarity of from 50 to 100%. According to another advantageous embodiment of the invention, the glass sheet has a clarity of from 70 to 100%.

According to an advantageous embodiment of the invention, the glass sheet has a gloss value at 60° of from 20 to 110 SGU. According to an advantageous embodiment of the invention, the glass sheet has a gloss value at 60° of from 50 to 110 SGU. More preferably, the glass sheet has a gloss value at 60° of from 50 to 100 SGU.

According to another advantageous embodiment of the invention, the glass sheet has a gloss value at 60° of from 20 to 50 SGU.

According to an advantageous embodiment of the invention the glass sheet have a surface roughness defined as measured on an evaluation length of 12 mm and with a Gaussian filter of which the cut-off wavelength is 0.8 mm, by:

0.02≤Ra≤0.4 μm,

5≤RSm≤15 μm,

said glass sheet having the following optical properties, when measured from said antireflective, etched surface:
a haze value of from 30 to 40%;
a clarity value of from 50 to 100%;
a gloss value at 60° of from 20 to 50 SGU.

To quantify the glass transmission in the visible range, we define light transmission (TL) calculated between the wavelengths of 380 and 780 nm according to the ISO9050 standard and measured with the D65 illuminant such as defined by ISO/CIE 10526 standard by considering the standard colorimetric observer CIE 1931 as defined by the ISO/CIE 10527 standard under a solid viewing angle of 2°. The glass sheet according to the invention preferably has a light transmission TL of at least 85%, preferably at least 90%.

The glass sheet according to the invention is made of glass whose matrix composition is not particularly limited and may thus belongs to different glass categories. The glass may be a soda-lime-silicate glass, an alumino-silicate glass, an alkali-free glass, a boro-silicate glass, etc. Preferably, the glass sheet of the invention is made of a soda-lime glass or an alumino-silicate glass.

According to an embodiment of the invention, the glass sheet has a composition comprising, in a content expressed in percentages of the total weight of the glass:

| | |
|---|---|
| SiO₂ | 55-85% |
| Al₂O₃ | 0-30% |
| B₂O₃ | 0-20% |
| Na₂O | 0-25% |
| CaO | 0-20% |
| MgO | 0-15% |
| K₂O | 0-20% |
| BaO | 0-20%. |

In a preferred manner, the glass sheet has a composition comprising, in a content expressed in percentages of the total weight of the glass:

| | |
|---|---|
| SiO₂ | 55-78% |
| Al₂O₃ | 0-18% |
| B₂O₃ | 0-18% |
| Na₂O | 5-20% |
| CaO | 0-10% |
| MgO | 0-10% |
| K₂O | 0-10% |
| BaO | 0-5%. |

In a more preferred manner, the glass sheet has a composition comprising, in a content expressed in percentages of the total weight of the glass:

| | |
|---|---|
| SiO₂ | 65-78% |
| Al₂O₃ | 0-6% |
| B₂O₃ | 0-4% |
| CaO | 0-10% |
| MgO | 0-10% |
| Na₂O | 5-20% |
| K₂O | 0-10% |
| BaO | 0-5%. |

Such a soda-lime-type base glass composition has the advantages to be inexpensive even if it is less mechanically resistant as such.

Ideally, according to this last embodiment, the glass composition does not comprise B₂O₃ (meaning that it is not intentionally added, but could be present as undesired impurities in very low amounts).

In an alternative more preferred manner, the glass sheet has a composition comprising, in a content expressed in percentages of the total weight of the glass:

| | |
|---|---|
| SiO₂ | 55-70% |
| Al₂O₃ | 6-18% |
| B₂O₃ | 0-4% |
| CaO | 0-10% |
| MgO | 0-10% |
| Na₂O | 5-20% |
| K₂O | 0-10% |
| BaO | 0-5%. |

Such an alumino-silicate-type base glass composition has the advantages to be more mechanically resistant but it is more expensive than soda-lime.

Ideally, according to this last embodiment, the glass composition does not comprise B₂O₃ (meaning that it is not intentionally added, but could be present as undesired impurities in very low amounts).

According to an advantageous embodiment of the invention, combinable with previous embodiments on base glass composition, the glass sheet has a composition comprising a total iron (expressed in terms of Fe₂O₃) content ranging from 0.002 to 0.06 weight %. A total iron (expressed in the form of Fe₂O₃) content of less than or equal to 0.06 weight % makes it possible to obtain a glass sheet with almost no visible coloration and allowing a high degree of flexibility in aesthetic designs (for example, getting no distortion when white silk printing of some glass elements of smartphones). The minimum value makes it possible not to be excessively damaging to the cost of the glass as such, low iron values often require expensive, very pure, starting materials and also purification of these. Preferably, the composition comprises a total iron (expressed in the form of Fe₂O₃) content ranging from 0.002 to 0.04 weight %. More preferably, the composition comprises a total iron (expressed in the form of Fe₂O₃) content ranging from 0.002 to 0.02 weight %. In the most preferred embodiment, the composition comprises a total iron (expressed in the form of Fe₂O₃) content ranging from 0.002 to 0.015 weight %.

According to another embodiment of the invention, in combination with previous embodiments on Fe₂O₃ content, the glass has a composition comprising chromium in a content such as: 0.0001%≤Cr₂O₃≤0.06%, expressed in percentages of the total weight of glass. Preferably, the glass has a composition comprising chromium in a content such as: 0.002%≤Cr₂O₃≤0.06%. This chromium content allows getting a glass with a higher IR transmission and it is thus advantageous when using the glass sheet in a touch panel using optical IR touch technologies like, for example, the Planar Scatter Detection (PSD) or Frustrated Total Internal Reflection (FTIR) (or any other technology requiring high transmission of IR radiation) in order to detect the position of one or more objects (for example, a finger or a stylus) on a surface of the glass sheet.

According to a preferred embodiment, the glass sheet of the invention is a float glass sheet. The term “float glass sheet” is understood to mean a glass sheet formed by the float process, which consists in pouring the molten glass onto a bath of molten tin, under reducing conditions. A float glass sheet comprises, in a known way, a “tin face”, that is to say a face enriched in tin in the body of the glass close to the surface of the sheet. The term “enrichment in tin” is understood to mean an increase in the concentration of tin with respect to the composition of the glass at the core, which may or may not be substantially zero (devoid of tin). Therefore, a float glass sheet can be easily distinguished from sheets obtained by other glassmaking processes, in particular by the tin oxide content which may be measured, for example, by electronic microprobe to a depth of ˜10 μm.

According to another preferred embodiment, the glass sheet of the invention is a glass sheet formed by a slot draw process or by a fusion process, in particular the overflow downdraw fusion process. These processes, in particular the fusion process produces glass sheets whose surfaces may reach superior flatness and smoothness necessary in some applications, but they are also more expensive than the float process for large scale glass production.

The glass sheet according to the invention may have a thickness of from 0.1 to 25 mm. Advantageously, in the case of display applications, the glass sheet according to the invention has preferably a thickness of from 0.1 to 6 mm. More preferably, in the case of display applications and for reasons of weight, the thickness of the glass sheet according to the invention is of from 0.1 to 2.2 mm.

According to one embodiment of the invention, the glass sheet is coated with at least one transparent and electrically conducting thin layer on the glass face opposite to the antireflective, etched surface. A transparent and conducting thin layer according to the invention can, for example, be a layer based on fluorine- or antimony-doped tin oxide or indium tin oxide, aluminium- or Gallium-doped zinc oxide or any other transparent conductive oxide.

The invention also relates to a glass sheet according to the invention which is chemically strengthened or tempered. All previously described embodiments also apply to the invention of chemically strengthened or tempered glass sheet.

The invention also relates to a glass sheet according to the invention which is thermally tempered. All previously described embodiments also apply to the invention of thermally tempered glass sheet.

Finally, the invention also relates to a display device comprising a glass sheet according to the invention. All previously described embodiments for the glass sheet also apply to the invention of display device.

Embodiments of the invention will now be further described, by way of examples only, together with some comparative examples, not in accordance with the invention. The following examples are provided for illustrative purposes, and are not intended to limit the scope of this invention.

The person skilled in the art realizes that the present invention by no means is limited to the preferred embodiments described above. On the contrary, many modifications and variations are possible within the scope of the appended claims.

### EXAMPLE

Reference examples R1, R2, R3, and R4 are flat glass sheets that are chemically etched on one major surface and that were prepared according to the method disclosed in EP3166900 A1 and incorporated by reference herein. R1, R2, and R3 are prepared from normal clear soda-lime float glass of 0.95 mm thickness. R4 is prepared from aluminosilicate glass of 1.1 mm thickness.

The examples 1 to 12 according to the present invention were prepared, starting from reference examples R1, R2, or R3 according to the various parameters detailed in the tables below using an RCE ion source for generating a beam of single charge and multicharge ions of N. The ion source used was a Hardion+RCE ion source from Ionics SA.

All samples had a size of 10×10 cm² and were treated on the entire etched surface by displacing the glass substrate through the ion beam at a speed between 20 and 30 mm/s.

The temperature of the area of the glass substrate being treated was kept at a temperature less than or equal to the glass transition temperature of the glass substrate.

For all examples the implantation was performed in a vacuum chamber at a pressure of 10⁻⁶ mbar.

TABLE 1

Acceleration

| | Reference | Voltage | Dose |
|---|---|---|---|
| Example | glass | (kV) | (ions/cm²) |
| 1 | R1 | 20 | 6.4 × 10¹⁶ |
| 2 | R2 | 20 | 6.4 × 10¹⁶ |
| 3 | R3 | 20 | 6.4 × 10¹⁶ |
| 4 | R1 | 20 | 6.8 × 10¹⁶ |
| 5 | R2 | 20 | 6.8 × 10¹⁶ |
| 6 | R3 | 20 | 6.8 × 10¹⁶ |
| 7 | R1 | 20 | 7.2 × 10¹⁶ |
| 8 | R2 | 20 | 7.2 × 10¹⁶ |
| 9 | R3 | 20 | 7.2 × 10¹⁶ |
| 10 | R1 | 20 | 7.6 × 10¹⁶ |
| 11 | R2 | 20 | 7.6 × 10¹⁶ |
| 12 | R3 | 20 | 7.6 × 10¹⁶ |

Comparative Example C1 was prepared from Reference glass R4. A four layer antireflective coating was deposited by magnetron sputtering on the etched face of the glass. The antireflective stack was the following: Glass/TiO₂/SiO₂/TiO₂/SiO₂. In the sequence starting from the glass, the first TiO₂ layer had a thickness between 8 and 16 nm, the second TiO₂ layer had a thickness between 95 and 115 nm, the first SiO₂ layer had a thickness between 28 and 40 nm, and the second SiO₂ layer had a thickness between 78 and 90 nm. The TiO₂ used had a refractive index at a wavelength of 550 nm of about 2.4 and the SiO₂ used had a refractive index at a wavelength of 550 nm of about 1.5.

### Texture and Optical Properties

Each of the glass sheets from Examples 1-4 were analyzed in terms of texture/surface roughness and optical properties.

Surface roughness measurements were performed using a 3D optical profiler Leica Type DCM3D, using the “Leica map” software, on an evaluation length of 12 mm and with a Gaussian filter of which the cut-off wavelength is 0.8 mm. The sample is first cleaned with detergent and dried. It is then placed under the microscope and after conventional settings, the profile of a 2D acquisition is then initiated (the software applies a default cut-off wavelength λs of 2.5 μm).

Haze and clarity measurements were performed according to ASTM standard D1003-11 with illuminant A2.

Gloss measurements were performed according to ASTM standard D523-14 at a specific angle of 60°, using a certified black glass standard with a gloss at 60° of 96.0.

Sparkle is the result of the interaction between two structured layers: the pixel matrix of the display and the random surface structures of the anti-glare layer. Measuring the sparkle effect is made according to the method disclosed by the company “Display-Messtechnik & Systeme”, using the apparatus SMS-1000. For evaluation of the sparkle intensity modulation caused by the pixel matrix of the display have to be separated from random intensity modulations from sparkling. Numerical image of the display glass surface is recorded for two different exposures corresponding to limited translation. A difference image is created. The level of sparkle is evaluated by dividing the standard deviation of a selected region in the sparkling area by the mean value of the same region of one of the original images.

The conditions selected to operate are:
pixel ratio 264 (distance from the screen 40 cm)
1 filter
intensity 240

For sparkle measurement each sample is placed on an Apple iPad4 retina display showing a green background image, with its antireflective, etched surface directed towards the camera.

Transmittance and reflectance measurements were performed using an UltraScan PRO Spectrophotometer from Hunter Associates Laboratory, Inc. Colors in reflection were measured using a Perkin Elmer Lambda 950 spectrophotometer with an ARTA accessory for angular resolved reflectance measurements.

As can be seen in Table 2 below, the surface roughness parameters show little difference after ion implantation or after deposition of the antireflective coating.

TABLE 2

| | Ref. | Ra | Rz | Rsm |
|---|---|---|---|---|
| Example | glass | (μm) | (μm) | (μm) |
| 1 | R1 | 0.094 | 0.529 | 21 |
| 2 | R2 | 0.124 | 0.690 | 18 |
| 3 | R3 | 0.138 | 0.781 | 18 |
| 4 | R1 | 0.090 | 0.590 | 20 |
| 5 | R2 | 0.122 | 0.714 | 19 |
| 6 | R3 | 0.140 | 0.770 | 18 |
| 7 | R1 | 0.093 | 0.556 | 19 |
| 8 | R2 | 0.120 | 0.701 | 18 |
| 9 | R3 | 0.139 | 0.844 | 18 |
| 10 | R1 | 0.085 | 0.578 | 20 |
| 11 | R2 | 0.120 | 0.725 | 19 |
| 12 | R3 | 0.142 | 0.776 | 18 |
| R1 | | 0.091 | 0.525 | 20 |
| R2 | | 0.117 | 0.691 | 18 |
| R3 | | 0.134 | 0.779 | 18 |
| C1 | R4 | 0.050 | 0.382 | 22 |
| R4 | | 0.048 | 0.409 | 23 |

The resulting optical properties are summarized in Table 3 below.

TABLE 3

| | Haze | Clarity | Gloss | Sparkle | TL | Rc | | |
|---|---|---|---|---|---|---|---|---|
| Ex. | (%) | (%) | (SGU) | (%) | (%) | (%) | a*_{Rc} | b*_{Rc} |
| 1 | 16.1 | 90.3 | 52.5 | | 91.1 | 6.9 | −0.09 | −0.38 |
| 2 | 20.3 | 81.9 | 35.7 | 3.4 | 90.7 | 6.9 | −0.07 | −0.45 |
| 3 | 25.1 | 74.8 | 25.5 | 3.72 | 90.5 | 6.9 | −0.08 | −0.44 |
| 4 | 16.1 | 90.3 | 47.6 | 2.7 | 92.4 | 5.7 | 0.30 | −0.27 |
| 5 | 20.3 | 81.9 | 32.1 | 3.7 | 92.0 | 5.8 | 0.24 | −0.15 |
| 6 | 25.1 | 74.8 | 23.7 | 3.7 | 91.4 | 5.9 | 0.17 | −0.05 |
| 7 | 16.1 | 90.3 | 49.0 | 2.6 | 92.0 | 5.9 | 0.20 | 0.22 |
| 8 | 20.3 | 81.9 | 32.6 | 3.5 | 91.9 | 5.9 | 0.20 | 0.24 |
| 9 | 25.1 | 74.8 | 24.0 | 3.7 | 91.4 | 6.0 | 0.17 | 0.27 |
| 10 | 16.1 | 90.3 | 48.0 | 2.5 | 92.3 | 5.8 | 0.26 | −0.09 |
| 11 | 20.3 | 81.9 | 32.0 | 3.4 | 92.0 | 5.7 | 0.30 | 0.14 |
| 12 | 25.1 | 74.8 | 24.1 | 3.8 | 91.5 | 5.9 | 0.22 | −0.15 |
| R1 | 15.6 | 90.6 | 60.3 | 2.6 | 90.0 | 8.0 | −0.21 | −0.80 |
| R2 | 20.4 | 82.1 | 39.7 | 3.4 | 89.7 | 8.0 | −0.21 | −0.78 |
| R3 | 25.8 | 74.4 | 28.1 | 3.8 | 89.4 | 8.0 | −0.23 | −0.77 |
| C1 | 10.8 | 98.2 | 78.6 | 1.5 | 94.4 | 4.3 | −0.16 | −1.86 |
| R4 | 11.7 | 98.2 | 89.9 | 1.2 | 90.8 | 7.8 | −0.18 | −0.86 |

As can be seen, the ion implantation leads to a reduction of the reflectance, while Haze, Clarity and Sparkle are not significantly affected. The ion implantation leads to a reduction of the gloss values. On comparative example C1 we can see that Haze and Clarity are not significantly affected by the addition of the coating and that gloss is reduced. However we see that Sparkle is significantly increased, by about 20%.

Furthermore some samples were selected for measuring the angular variation of reflected color. The measurement values are shown in table 4 below.

TABLE 4

| Example | a*_{Rc(8°)} | a* _{Rc(35°)} | b* _{Rc(8°)} | b* _{Rc(35°)} | Δa*b* _{Rc(35°)} |
|---|---|---|---|---|---|
| 1 | −0.09 | 0.13 | −0.38 | 0.75 | 0.68 |
| R1 | −0.21 | −0.04 | −0.80 | −0.02 | 0.59 |
| C1 | −0.16 | −0.26 | −1.86 | −0.69 | 1.75 |
| R4 | −0.18 | −0.04 | −0.86 | −0.65 | 0.91 |

As can be seen from table 4, the angular color variation between an angle of 35° and an angle of 8° of ion implanted example 1 is quite small and close to the values obtained on the reference glass R1. The antireflective coating of comparative example C1 however leads to a significant increase of the angular color variation when compared to its reference glass R4.

1. A glass sheet comprising at least one antireflective, etched surface having a surface roughness defined, when measured on an evaluation length of 12 mm and with a Gaussian filter of which a cut-off wavelength is 0.8 mm, by:
0.02≤Ra≤0.6 μm;
0.1≤Rz≤3 μm and; and
5≤RSm≤180 μm,
wherein the antireflective, etched surface comprises implanted ions of O, N, He, Ne, Ar, or Kr, with an implantation depth comprised between 0.1 μm and 1 μm, said glass sheet having the following optical properties, when measured from said antireflective, etched surface:
a haze value of from 1 to 40%;
a clarity value of from 30 to 100%;
a gloss value at 60° of from 20 to 130 SGU; and
a luminous reflectance Rc from 4 to 7%.

2. The glass sheet according to claim 1, wherein an angular variation of a color in reflection between 8° and 35° Δa*b*_{Rc(35°)} is at most 1.5.

3. The glass sheet according to claim 1, wherein an angular variation of a color in reflection between 8° and 35° Δa*b*_{Rc(35°)} is at most 1.

4. The glass sheet according to claim 1, wherein an angular variation of a color in reflection between 8° and 35° Δa*b*_{Rc(35°)} is at most 0.7.

5. The glass sheet according to claim 1, wherein an angular variation of a color in reflection between 8° and 35° Δa*b*_{Rc(35°)} is at most 0.5.

6. The glass sheet according to claim 1, wherein a color in reflection is 2≤a*_{Rc}≤2 and 2≤b*_{Rc}≤2.

7. The glass sheet according to claim 1, wherein a color in reflection is 1≤a*_{Rc}≤1 and 1≤b*_{Rc}≤1.

8. The glass sheet according to claim 1, wherein a color in reflection is 0.5≤a*_{Rc}≤0.5 and 0.5≤b*_{Rc}≤0.5.

9. The glass sheet according to claim 1, wherein a color in reflection is 0.3≤a*_{Rc}≤0.3 and 0.3≤b*_{Rc}≤0.3.

10. The glass sheet according to claim 1, wherein a color in reflection is 3≤a*_{Rc}≤3 and 20≤b*_{Rc}≤−3.

11. The glass sheet according to claim 1, wherein the glass sheet has a surface roughness defined by 0.02≤Ra≤0.4 μm.

12. The glass sheet according to claim 1, wherein the glass sheet has a surface roughness defined by 0.02≤Ra≤0.2 μm.

13. The glass sheet according to claim 1, wherein the glass sheet has a surface roughness defined by 10≤RSm≤180 μm.

14. The glass sheet according to claim 1, wherein the glass sheet has a surface roughness defined by 10≤RSm≤140 μm.

15. The glass sheet according to claim 1, wherein the glass sheet has a surface roughness defined by 10≤RSm≤100 μm.

16. The glass sheet according to claim 1, wherein the glass sheet has a surface roughness defined by 10≤RSm≤60 μm.

17. The glass sheet according to claim 1, wherein the glass sheet has a surface roughness defined by 10≤RSm≤30 μm.

18. A method for reducing reflectance of an etched glass surface comprising:
providing a source gas selected from O2 or N2, He, Ne, Ar, or Kr;
ionizing the source gas so as to form positively charged ions of O, N, He, Ne, Ar, or Kr,
accelerating the positively charged ions of O, N, He, Ne, Ar, or Kr with an acceleration voltage comprised from 5 kV to 100 kV,
providing an etched glass sheet having an etched side, the etched side having a surface roughness defined, when measured on an evaluation length of 12 mm and with a Gaussian filter of which a cut-off wavelength is 0.8 mm, by:
0.02≤Ra≤0.6 μm,
0.1≤Rz≤3 μm, and
5≤RSm≤180 μm,
positioning the etched glass sheet in a trajectory of the beam of positively charged ions of O, N, He, Ne, Ar, or Kr with the etched side facing the beam for a duration necessary to obtain an ion dosage comprised from 5×10¹⁴ ions/cm² to 10¹⁸ ions/cm².

19. The method of claim 18, wherein the source is selected from O₂ or N₂.

20. The method of claim 18, wherein the positioning the etched glass sheet in the trajectory of the beam of positively charged ions of O, N, He, Ne, Ar, or Kr with the etched side facing the beam is for a duration necessary to obtain an ion dosage comprised from 10¹⁶ ions/cm² to 5×10¹⁷ ions/cm².

21. The method of claim 1, wherein the positioning the etched glass sheet in the trajectory of the beam of positively charged ions of O, N, He, Ne, Ar, or Kr with the etched side facing the beam is for a duration necessary to obtain an ion dosage comprised from 5×10¹⁶ ions/cm² to 10¹⁷ ions/cm².

22. A display device comprising a glass sheet according to claim 1.
